(19) United States
(12) Patent Application Publication
(10) Pub. No.: US 2026/0180636 A1
(43) Pub. Date: Jun. 25, 2026

(54) METHOD FOR SIGNALLING DISJOINT WIDE BEAMS

(71) Applicant: Sony Group Corporation, Tokyo (JP)

(72) Inventors: Fredrik RUSEK, Eslöv (SE); Jose FLORDELIS, Lund (SE); Erik BENGTSSON, Eslöv (SE); Olof ZANDER, Södra Sandby (SE); Kun ZHAO, Malmö (SE)

(21) Appl. No.: 19/124,864

(22) PCT Filed: Nov. 6, 2023
(86) PCT No.: PCT/EP2023/080844

§ 371 Date: Apr. 26, 2025

(30) Foreign Application Priority Data
Nov. 11, 2022 (SE) 2251325-3

(51) Int. Cl. H04B 7/06; H04W 24/10

(52) U.S. Cl. CPC H04B 7/0617; H04W 24/10

(57) ABSTRACT

Disclosed is a method performed by a network node. The method comprises receiving, from a coverage enhancing device (CED), control signalling indicative of the CED retransmitting an incident signal as a disjoint wide beam comprising a plurality of subbeams.

### TECHNICAL FIELD

The present disclosure pertains to the field of wireless communications. The present disclosure relates to network nodes that may be configured to receive control signalling indicative of a coverage enhancing device (CED) being intended to retransmit a disjoint wide beam and to CEDs that may be configured to send such control signalling.

### BACKGROUND

Beamforming with a large antenna array may be regarded as a long-standing problem in the field of communication theory. When non-stringent restrictions are applied to the antenna array, beamforming might not be especially challenging. For example, if no restrictions are imposed to the beamforming coefficients to be applied per antenna array, a Slepian beam class may be an excellent choice according to natural metrics.

### SUMMARY

However, when some form of more demanding restriction on the beamforming coefficients is considered, problems affecting beamforming may arise. Among the most severe restrictions may be that the beamforming coefficients have constant magnitude (that is, the beamforming coefficients all have equal magnitude) and a finite number K of phase levels (such that the coefficients are in the set {e^{i2πk/K}, k=0 . . . K−1}), for example two different phase values (such as the beamforming coefficients being taken from the set {±1}). Such restrictions may be the result of a simple and low-cost hardware implementation in the antenna array. For example, with {±1} beamforming coefficients, wide beam generation with Slepian beams may no longer be available.

There may be a need for network nodes, coverage enhancing devices (CEDs) and methods which may mitigate, alleviate or address the existing shortcomings and may provide for a satisfactory generation of wide beams even when constraints are imposed to the beamforming coefficients of an antenna array, such as a CED.

In particular, there may be a need to create wide beams using a very limited number of phase levels, and a single constant amplitude level. Such wide beams might not be wide in the conventional sense (namely, a beam having a large continuous range of angles of departure (AoDs) in which high power is sent), which may not be accomplished with certain hardware constraints. Such wide beams that are not wide in the conventional sense may be wide beams that have multiple disjoint narrow ranges of AoDs with high power, referred to herein as “disjoint wide beams”. For example, high power is sent by a uniform linear array in the azimuth ranges [−30°, −25°], [−5°, 0°], [15°, 20°] and [45°, 50°]. This is, in some sense, equally wide as a conventional, continuous beam with high power in the azimuth range [−10°, 10°].

If disjoint wide beams are redirected by a CED, and a network node is unaware that the beams are not continuous, problems may arise.

Disclosed is a method performed by a network node. The method comprises receiving, from a coverage enhancing device (CED), control signalling indicative of the CED retransmitting an incident signal as a disjoint wide beam comprising a plurality of sub-beams.

A network node is provided. The network node comprises memory circuit, processor circuitry, and a wireless interface. The network node is configured to perform any of the methods disclosed herein.

The network node, and the method performed by it, may be advantageous in that, since the network node may receive information from the CED regarding the disjoint nature of the wide beam, the network node may adapt its response to any reduction of the performance or malfunctioning in the communication between the network node and the wireless device to the characteristics of the disjoint wide beam. In other words, the network node may allow for a satisfactory communication quality even when hardware constraints are present in the CED and disjoint wide beams are redirected by the CED.

Disclosed is a method performed by a coverage enhancing device (CED). The method comprises transmitting, to a network node, control signalling indicative of the CED retransmitting an incident signal as a disjoint wide beam comprising a plurality of sub-beams.

A coverage enhancing device (CED) is provided. The CED comprises memory circuitry, processor circuitry, and a wireless interface. The CED is configured to perform any of the methods disclosed herein.

The CED and the method it may perform may be advantageous for the same reasons as set forth for the network node disclosed herein.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example network node, example wireless devices and an example server device according to this disclosure,

FIGS. 2A, 2B, 2C illustrate an example continuous wide beam in a first, a second and a third hierarchical level, according to this disclosure,

FIG. 3A illustrates an example disjoint wide beam in a first and a second hierarchical level, according to this disclosure,

FIG. 3B illustrates an example disjoint wide beam in a third hierarchical level, according to this disclosure,

FIG. 4 shows example recovery beams associated with a sub-beam in the third hierarchical level, according to this disclosure,

FIG. 5A depicts an example spatial distribution of sub-beams that may belong to a disjoint wide beam and/or to a recovery beam, according to this disclosure,

FIG. 5B schematically represents example configurations of the recovery beams and return beams, according to this disclosure,

FIG. 5C shows an example codebook of disjoint wide beams and their constituent beams in different hierarchical levels, according to this disclosure,

FIG. 6 shows an example disjoint wide beam with L=2, according to this disclosure,

FIG. 7 indicates example possible locations of the points of symmetry for blobs of a disjoint wide beam, according to this disclosure,

FIG. 8 represents example possible locations of the blobs of the disjoint wide beam relative to the points of symmetry of FIG. 7, according to this disclosure,

FIG. 9 is a signalling diagram illustrating an example communication between an example network node, an example coverage enhancing device, and an example wireless device according to the disclosure,

FIGS. 10A, 10B illustrate a flow-chart illustrating an example method performed by a network node according to this disclosure,

FIG. 11 illustrates a flow-chart illustrating an example method performed by a coverage enhancing device according to this disclosure,

FIG. 12 is a block diagram illustrating an example network node according to this disclosure, and

FIG. 13 is a block diagram illustrating an example coverage enhancing device according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

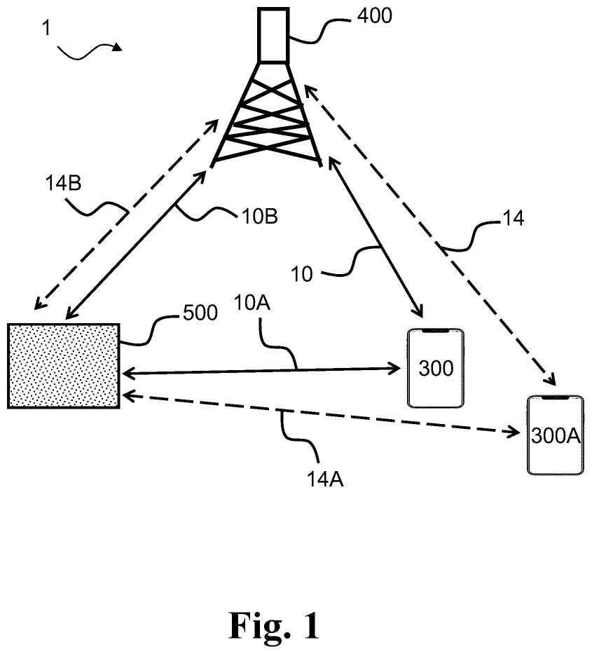

FIG. 1 is a diagram illustrating an example wireless communication system 1 comprising an example network node 400, example wireless devices 300, 300A and an example coverage enhancing device (CED) 500 according to this disclosure.

As discussed in detail herein, the present disclosure relates to a wireless communication system 1 comprising a cellular system, for example, a 3GPP wireless communication system. The wireless communication system 1 may comprise one or more wireless devices 300, 300A and one or more network nodes 400.

A network node disclosed herein refers to a radio access network node operating in the radio access network (RAN), such as one or more of: a base station, an evolved Node B, an eNB, a gNB in NR and an access point. In one or more examples, the RAN node is a functional unit which may be distributed in several physical units.

A wireless device may refer to one or more of: a mobile device and a user equipment (UE).

The wireless devices 300, 300A may be configured to communicate with the network node 400 via a wireless link (or radio access link) 10, 14 respectively.

The present disclosure may involve downlink (DL), sidelink (SL) and uplink (UL) transmissions.

The wireless communication system 1 of FIG. 1 may comprise one or more CEDs 500. The CED 500 may be configured to redirect signals between other components of the wireless communication system 1, such as the wireless devices 300, 300A and the network node 400.

In the embodiment of FIG. 1, a first wireless device 300 may be configured to communicate with the network node 400 via a first wireless link (or radio access link) 10A, 10B, in which the signals between the first wireless device 300 and the network node 400 are redirected by the CED 500. In the embodiment of FIG. 1, a second wireless device 300A may be configured to communicate with the network node 400 via a second wireless link (or radio access link) 14A, 14B, in which the signals between the first wireless device 300 and the network node 400 are redirected by the CED 500.

Components of the disclosed CEDs, such as the active components and passive components, can be advantageous to redirect signals. As disclosed herein, redirecting can include one or more of: transmitting, reflecting, forwarding, scattering, regenerating, re-radiating, directing, retransmitting a signal and allowing a signal to pass through. Redirecting, transmitting, and retransmitting may be used interchangeably. The redirecting may include altering direction, polarisation or both direction and polarisation of a signal. The redirecting may include one or more of: amplification, attenuation, termination, phase shifting, delaying and spatial manipulation of a signal. Spatial manipulation may be, for instance, splitting into multiple components, widening or in general applying any spatial filtering.

For example, the CEDs may redirect an incoming signal from a given incoming direction to a given outgoing direction. Components of the CEDs can be used to redirect signals in the mm wave spectrum, in the sub 7 GHz spectrum, in the sub 6 GHz spectrum or in any other spectrum which may be used. Further, the components of the CEDs can be configured to make redirections of signals which appear in-phase in one or more of: a direction, an area or a volume.

The coverage enhancing devices can be used for network management. The coverage enhancing devices can be used for beam management, panel management or both beam management and panel management. The coverage enhancing devices can be used for far-field propagation, near-field propagation or both far-field propagation and near-field propagation. The coverage enhancing devices can utilize one or more of: passive array panels, active array panels and intelligent surfaces to improve coverage and beamforming of signals.

The disclosed coverage enhancing devices can be one of a number of several types of devices, which can be used interchangeably herein. For example, the CEDs can be one or more of: reconfigurable intelligent surfaces (RISs), large intelligent surfaces (LISs), network configured repeaters, repeater nodes, repeater type devices, repeaters (such as regenerative and/or non-regenerative), intelligent surfaces and reconfigurable reflective devices (RRDs). The CEDs can have one or more antennas, such as one or more of: antenna panels, antenna elements, antenna inputs, antenna outputs and unit cells for meta-surfaces. The CEDs can have one or more receivers, for example low-power receivers. The CEDs can have one or more transmitters, such as an active component that provides amplification to a signal.

In one or more example wireless communication systems, the signals disclosed herein can be one or more of: energy, wave energy, FR1 and FR2 signals, 5G signals, 6G signals, sub-6 GHZ, sub-THz, THz, electromagnetic energy, waves, electromagnetic plane waves, electromagnetic signals, plane signals, spherical waves, spherical signals, cylindrical waves and cylindrical signals. As disclosed herein, waves and signals can be used interchangeably. Signals may include signals with any polarization properties. The particular type of signal is not limiting.

As disclosed herein, the terms signal, message and data can be used interchangeably.

As used herein, the terms emitted, sent, and transmitted can be used interchangeably.

When wide beams are applied on the CED 500, and the network node 400 is unaware that the wide beam are not continuous, problems may arise. A wide beam has by definition less gain than a narrow beam so, ideally, the wireless communication system 1 prefers narrow beams for serving the wireless device 300.

However, because some wireless devices 300 are movable, the network node 400 may choose to configure the CED 500 with a wide beam and keep this wide beam, despite its inherent gain loss, in order to be robust for wireless device mobility. When the wide beam is not continuous (that is, when it is a disjoint wide beam) and the wireless device 400 moves, the wireless device 400 may fall outside the local beamwidth of the constituent beam. Therefore, there may be a decrease in the robustness for wireless device mobility.

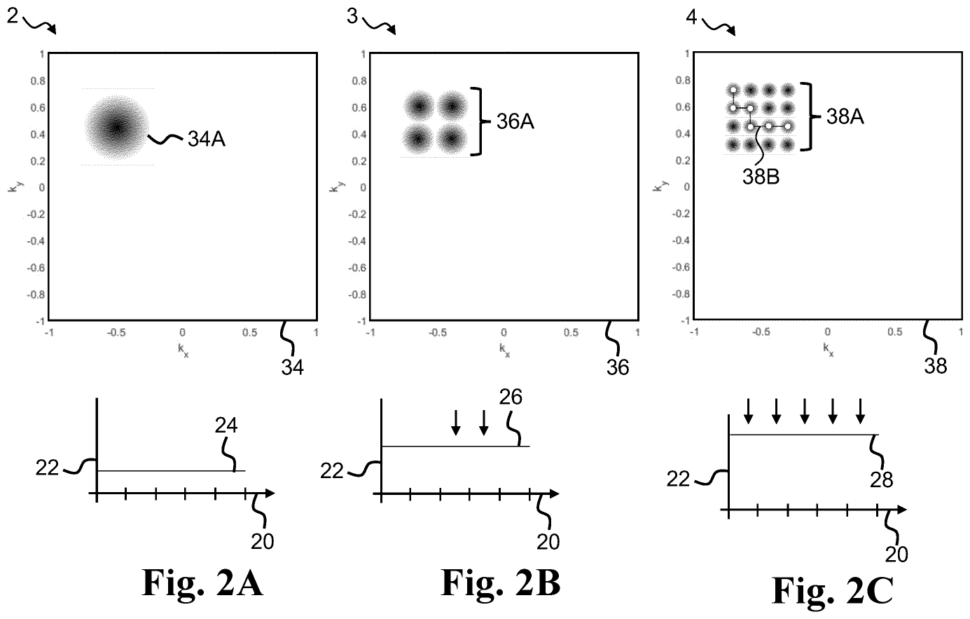

FIGS. 2A, 2B, 2C show an example of a wireless communication system equipped with three hierarchical levels, in which the first hierarchical level is a traditional (that is, continuous) wide beam. kx and ky refers to directional cosines which are defined in relation to a spherical coordinate system in the far-field. FIGS. 2A, 2B, 2C show translation of the input direction into an output direction, caused by the CED. As used herein, a “hierarchical level” of a beam relates to the number of constituent beams of the beam defined in a codebook (for example, in a hierarchical beam-tree), such that the higher the hierarchical level, the lesser the number of constituent beams.

In the example of FIGS. 2A, 2B, 2C, the beam which, according to a first hierarchical level 2 comprises one constituent beam 34A (FIG. 2A) that is a continuous wide beam, has four constituent beams 36A according to a second hierarchical level (FIG. 2B), and each of the constituent beams 36A according to the second hierarchical level 3 in turn comprises four constituent beams 38A according to a third hierarchical level 4 (FIG. 2C). Also shown in FIG. 2C is a wireless device trajectory 38B. To always serve the wireless device with the highest gain beam 22, there are five beam switches 28 during the wireless device trajectory 20 in the third hierarchical level 4. The wireless communication system has flexibility so that it can choose to use only, for example, constituent beams 36A of the second hierarchical level 3, which would result in two beam switches 26. The choice with the least overhead would be to always operate with the widest beam 34A of the first hierarchical level 2, which results in no beam switches 24 at all but at the expense of less gain 22.

In the example of FIGS. 2A, 2B, 2C, a constituent beam of the first hierarchical level 2 covers all constituent beams of the second hierarchical level 3 that originate from such constituent beam (for example, constituent beam 34A covers constituent beams 36A); and a constituent beam of the second hierarchical level 3 covers all constituent beams of the third hierarchical level 4 that originate from such constituent beam (for example, each constituent beam 36A covers four constituent beams 38A).

When retransmission occurs according to a particular level using the continuous wide beam of FIGS. 2A, 2B, 2C, only one constituent beam is activated at a time in the example of these figures.

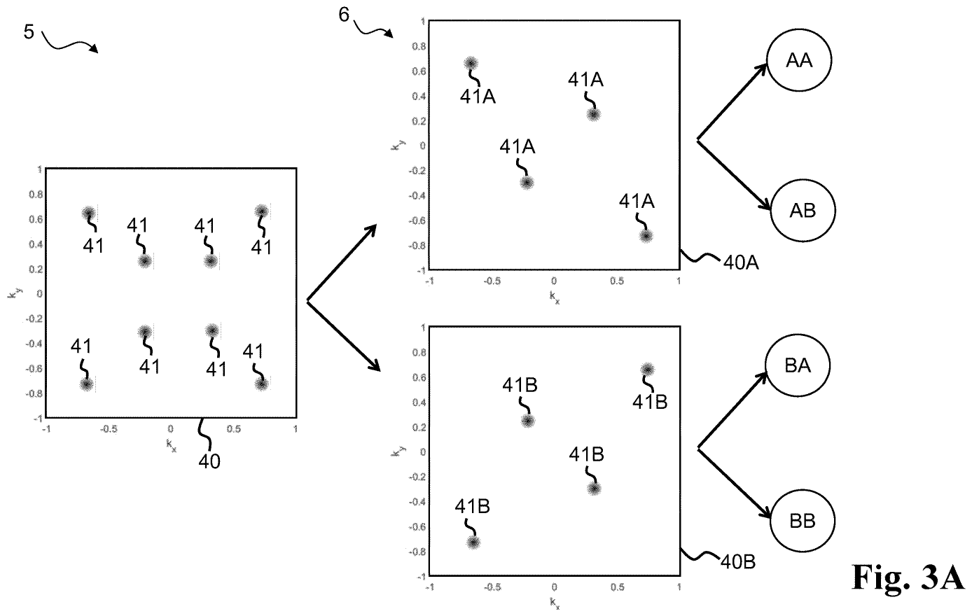

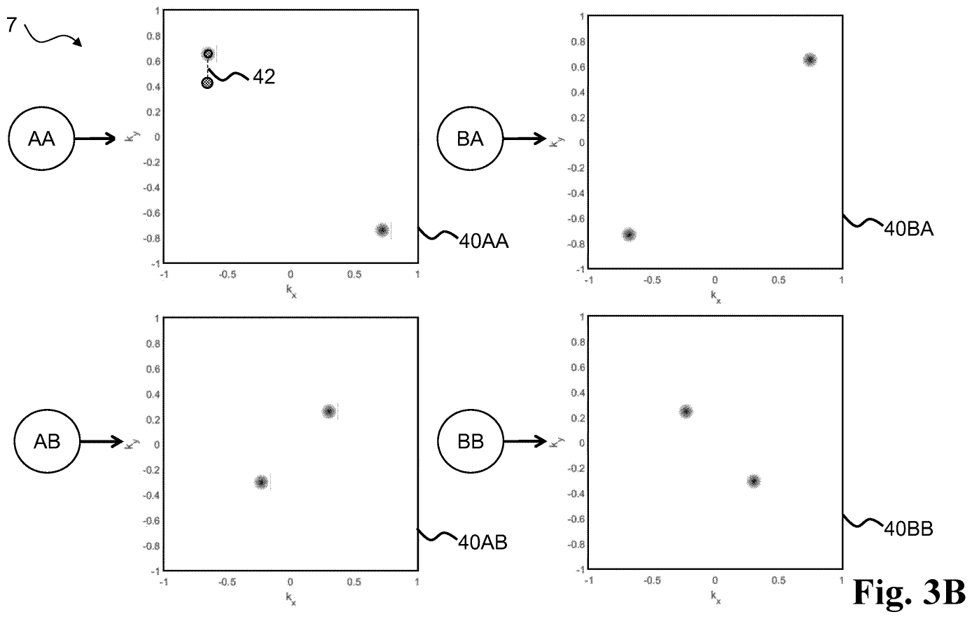

FIGS. 3A, 3B show an example of a wireless communication system equipped with three hierarchical levels, wherein the first hierarchical level corresponds to a disjoint wide beam 40.

The disjoint wide beam 40 of FIG. 3A, left comprises four sub-beams 41 (each sub-beam being composed of two blobs, as in some examples detailed below), according to a first hierarchical level 5. The disjoint wide beam of the first hierarchical level 5 comprises a first 40A and a second 40B constituent beam according to a second hierarchical level 6, respectively shown in the upper right graph and lower right graph, each constituent beam comprising two sub-beams 41A, 41B. In turn, the first constituent beam 40A according to the second hierarchical level 6 comprises two constituent beams 40AA, 40AB according to the third hierarchical level 7; and the second constituent beam 40B according to the second hierarchical level 6 comprises two constituent beams 40BA, 40BB according to the third hierarchical level 7 (shown in FIG. 3B). Each constituent beam 40AA, 40AB, 40BA, 40BB according to the third hierarchical level 7 comprises one sub-beam (which is formed of two blobs). The beam gain of the narrow constituent beams 40AA, 40AB, 40BA, 40BB of the third hierarchical level 7 is four times that of the disjoint wide beam 40 of the first hierarchical level 5. As in the example of FIGS. 2A, 2B, 2C, a constituent beam of the first hierarchical level 5 of FIG. 3A covers all constituent beams of the second hierarchical level 6 that originate from such constituent beam (for example, constituent beam 40 covers constituent beams 40A, 40B); and a constituent beam of the second hierarchical level 6 covers all constituent beams of the third hierarchical level 7 that originate from such constituent beam (for example, constituent beam 40A covers constituent beams 40AA, 40AB).

When retransmission occurs according to a particular level using the continuous wide beam of FIGS. 3A, 3B, only one constituent beam is activated at a time in the example of these figures.

In the example of FIGS. 3A, 3B, similarly to the example of FIGS. 2A, 2B, 2C, the areas covered by the activated constituent beam decreases as the rank of the hierarchical level decreases. For example, in the example of FIGS. 2A, 2B, 2C, the area covered by an activated constituent beam 38A of the third hierarchical level 4 is smaller than that of an activated constituent beam 36A of the second hierarchical level 3, which in turn is smaller than the area covered by the constituent beam 34A of the first hierarchical level 2. For example, in the example of FIGS. 3A, 3B, the area covered by an activated constituent beam 40AA of the third hierarchical level 7 is smaller than that of an activated constituent beam 40A of the second hierarchical level 6, which in turn is smaller than the area covered by the constituent beam 40 of the first hierarchical level 5.

In the example of FIGS. 2A, 2B, 2C, each individual constituent beam corresponds to a single sub-beam whose covered area varies in accordance with the rank of the hierarchical level, as explained herein. In the example of FIGS. 3A, 3B, the sub-beams that make up a certain constituent beam cover the same area in all the hierarchical levels. The difference between the areas covered by the constituent beams in the different hierarchical levels comes down to the number of sub-beams forming a certain constituent beam. For example, as detailed above, each constituent beam 40AA, 40AB, 40BA, 40BB according to the third hierarchical level 7 comprises one sub-beam, whilst each constituent beam according to the second hierarchical level 6 comprises two sub-beams 41A, 41B.

Also shown in FIG. 3B, upper left graph is a wireless device trajectory 42, for which it can be appreciated that there is no beam covering the wireless device trajectory, when the wireless device moves away from the geographical coverage of constituent beam 40AA in the third hierarchical level 7, in any of the hierarchies 5, 6, 7. Thus, contrary to the examples with continuous wide beams, such as that of FIGS. 2A, 2B, 2C, the wireless communication system may not be able to rely on a wide beam (such as the disjoint wide beam 40 of the first hierarchical level 5) to help the wireless device increase its mobility robustness. The disjoint wide beam 40 of the first hierarchical level 5 may solely be beneficial for reducing the time to find the narrowest beam, thus reducing overhead of beam management.

In the example of FIGS. 3A, 3B, when the wireless device moves, with associated reduction of gain, it does not suffice for the wireless communication system for instance to move up from the third hierarchical level 7 to the second hierarchical level 6. This may be different to the situation in which continuous beams are used, as in the example of FIGS. 2A, 2B, 2C, where higher hierarchical levels contain beams around the beams of the lower hierarchical level.

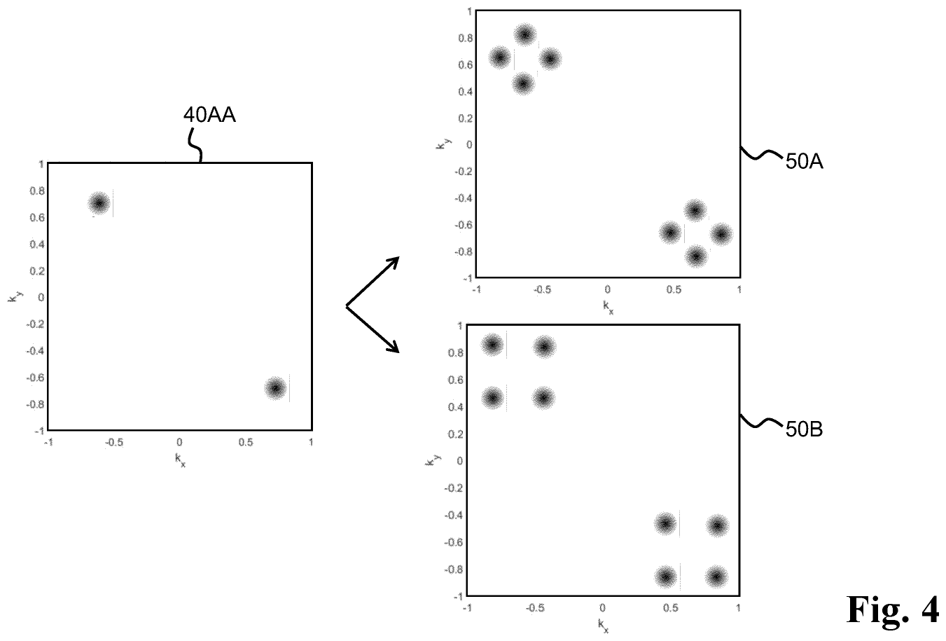

A codebook (for example, comprising a hierarchical beam-tree) may comprise an index of the disjoint wide beams (and their constituent beams according to the different hierarchical levels). This codebook may be provided with an index of recovery beams. The recovery beams have the purpose of reducing or avoiding beam connection loss in disjoint wide beams. Advantageously, the wireless communication system may, for example, use recovery beams 50A, 50B, as is shown in FIG. 4, to cover a new location of the wireless device around the area of coverage of constituent beam 40AA.

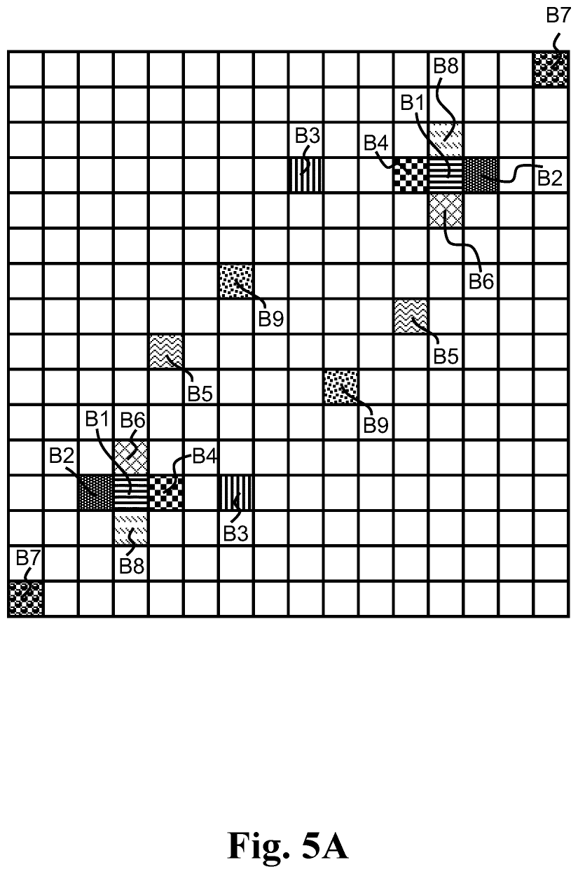

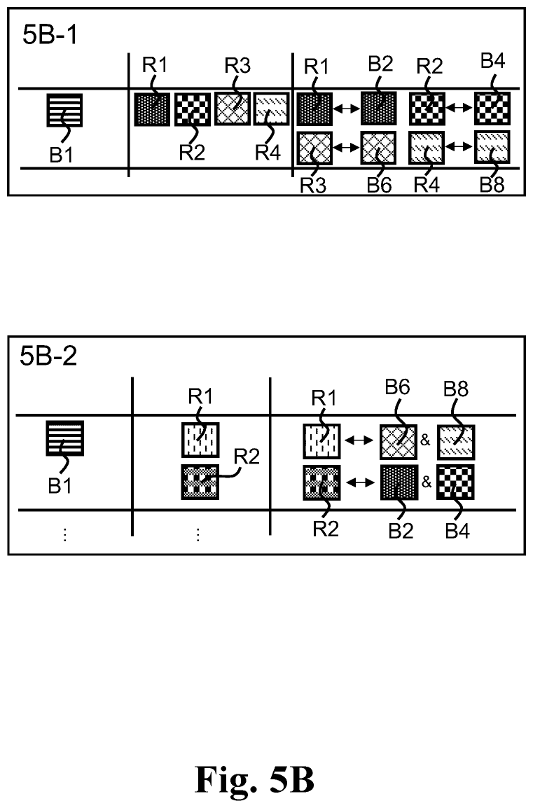

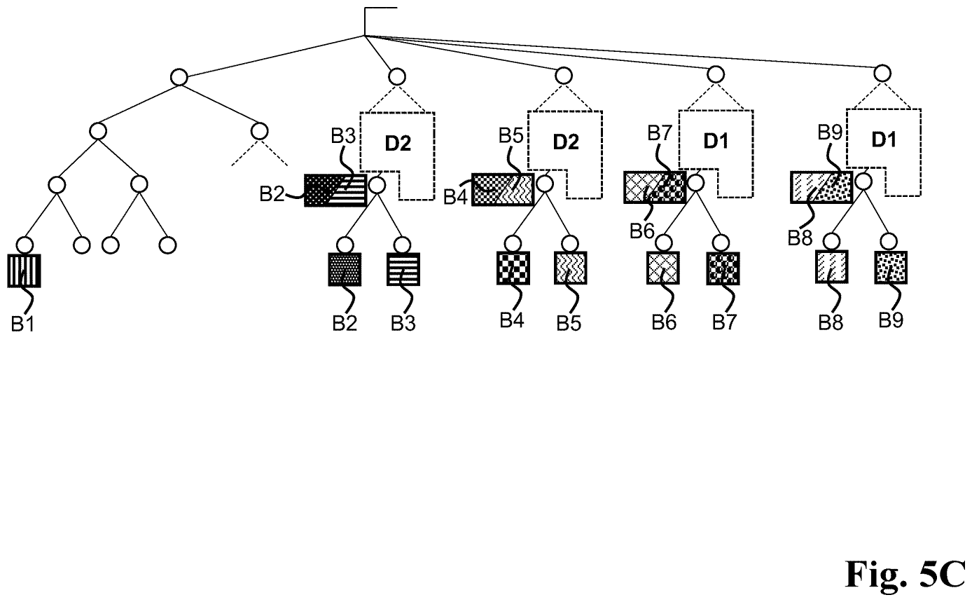

FIG. 5A depicts an example of recovery beams for a constituent beam B1, such as constituent beam 40AA according to the third hierarchical level 7 of FIG. 3B. As noted above, constituent beam B1 is made up of two blobs and is the current beam for the wireless device before the beam failure associated with the wireless device trajectory 42.

According to the second hierarchical level 6 (such as that of FIG. 3A, right), each constituent beam comprises two sub-beams/four blobs, for example sub-beams B2 and B3, or B4 and B5 of FIG. 5A; or sub-beams 41A, 41B in FIG. 3A, right.

According to the first hierarchical level 5 (such as that of FIG. 3A, left), a disjoint wide beam has four sub-beams/eight blobs; for example, sub-beams B2, B3, B4 and B5 may be a certain disjoint wide beam, such as the disjoint wide beam 40 of FIG. 3A, left.

When there is a beam failure in constituent beam B1 according to the third hierarchical level 7, moving up the hierarchical rank may not help to re-establish beam connection, as discussed above. The definition of recovery beams that corresponded to the index of disjoint wide beams (and their constituent beams according to the different hierarchical levels) may not be effective, as they are likely to comprise a sub-beam not around beam B1 (for example, a hypothetical recovery beam formed of sub-beam B8 and sub-beam B9 in FIG. 5A; note that sub-beam B9 is not around beam B1). Therefore, new recovery beams may be defined and indexed in the codebook, as represented in FIG. 5B.

In the example of FIG. 5B, the recovery beams may be associated with one (option 5B-1) or more (such as two, as in option 5B-2) return beams. The network node may be configured to only be aware of the code of the return beam associated with each beam of the third hierarchical level, but not of its location. The return beams may be seen as a pointer, in the codebook, that relates the index of return beams (for example, return beam R1 in FIG. 5B) to the index of the disjoint wide beams and their constituent beams according to the different hierarchical levels (for example, return beam R1 corresponds to constituent beam B2 according to the third hierarchical level, in option 5B-1; and to the constituent beam formed of sub-beams B6 and B8 according to the second hierarchical level, in option 5B-2).

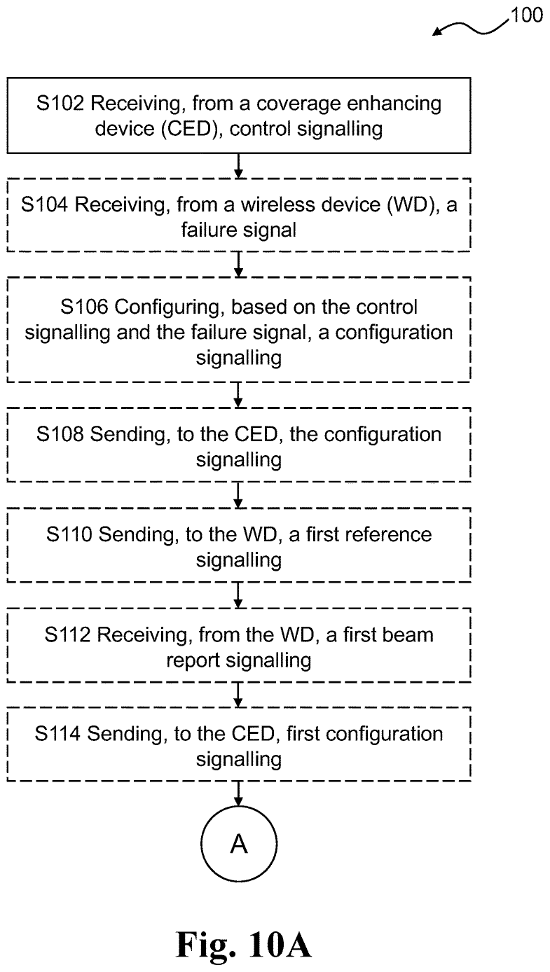

When there is a beam failure for constituent beam B1 in the third hierarchical level 7, the CED configures, in the example of FIG. 5B-1, the recovery beams R1, R2, and the wireless device reports which one is best, as will be also explained below with reference to FIG. 9. The network node then orders the CED to configure itself according to, for example, R1. The CED is aware that R1 is formed of beams B6 and B8 of the codebook of disjoint wide beams and their constituent beams according to the different hierarchical levels. If the wireless device reports that beam B8 is best to re-establish connection, the network node orders the CED to configure itself according to beam B8 (in the codebook, beam B8 would be indexed, for example, as disjoint wide beam D1, formed of sub-beams B6, B7, B8, B9 in the first hierarchical level; constituent beam formed of sub-beams B8 and B9 according to the second hierarchical level; constituent beam B8 in the third hierarchical level, which thus relates return beam R1 to the index of disjoint wide beams and their constituent beams). It follows from this that there is no need, at any stage of the process, for the network node to know more about the recovery beams than its index.

In the example of FIG. 5B-2, the recovery beams are associated with only one return beam. Therefore, the CED configures twice the number of recovery beams of the example of FIG. 5B-1 to cover the same amount of space around beam B1. Concretely, the CED configures, in the example of FIG. 4AB, recovery beams R1, R2, R3 and R4, and the wireless device reports which one is best to re-establish connection. The network node then orders the CED to configure according to, for example, R4. The CED is aware that R4 is formed of beam B8 of the codebook of disjoint wide beams and their constituent beams according to the different hierarchical levels. In the codebook, beam B8 would be indexed, for example, as disjoint wide beam D1, formed of sub-beams B6, B7, B8, B9 in the first hierarchical level; constituent beam formed of sub-beams B8 and B9 according to the second hierarchical level; constituent beam B8 in the third hierarchical level, which thus relates return beam R4 to the index of disjoint wide beams and their constituent beams.

The codebook of disjoint wide beams and their constituent beams according to the different hierarchical levels is schematically represented in the hierarchical beam-tree of FIG. 5C.

Some illustration, in form of equations, of this issue is shown below for an example. In this example, an array with M×N antennas applies beamforming coefficients {xₘₙ}. This generates a far-field beam pattern B(θ, φ), where θ, φ are spherical coordinates. An alternative and convenient representation of spherical coordinates are directional cosines, defined by:

$${k}_{x} = cos ( θ ) sin ( ϕ ) , {k}_{y} = sin ( θ ) sin ( ϕ ) .$$

For a transmit array, the directional cosines satisfy |kₓ|²+|k_{y}|²≤1, while no such restriction applies for beamforming at a reflective surface, such as a CED. In the following, we let B(kₓ, k_{y}) denote the beam pattern in the directional cosine domain.

Assuming a uniform rectangular array with M×N elements spaced λ/2 apart, the pattern B(kₓ, k_{y}) is related to {xₘₙ} by:

$$B ( {k}_{x} , {k}_{y} ) = {\sum }_{m = 1}^{M} {\sum }_{n = 1}^{N} {e}^{- i π ( m {k}_{x} + n {k}_{y} )} {x}_{m n} .$$

For later use, we note that this is a 2-D Fourier transform of {xₘₙ}.

As used herein, a wide beam may be defined as follows:

$$\vert B ( {k}_{x} , {k}_{y} ) \vert = \{ \begin{matrix}{‶}^{} {high}^{″} , & {k}_{x} , {k}_{y} ∈ F \\ {‶}^{} low , & {k}_{x} , {k}_{y} ∉ F\end{matrix}$$

where F is “large”, i.e., ∫_{F}dkₓdk_{y} is above a threshold.

Let us assume that we seek to maximize the beam pattern in a certain direction kₓ, k_{y}. Then it is possible to set

$${x}_{m n} = {x}_{m n}^{o p t} ( {k}_{x} , {k}_{y} ) ,$$

where:

$${x}_{m n}^{o p t} ( {k}_{x} , {k}_{y} ) = {e}^{i π ( m {k}_{x} + n {k}_{y} )} .$$

This results in |B(kₓ, k_{y})|²=(MN)², which may be seen to be optimal through the Cauchy-Schwarz inequality. Broadly speaking, we refer to both the coefficients

$${x}_{m n}^{o p t} ( {k}_{x} , {k}_{y} )$$

and the resulting beam as a “pencil beam”, such that it should clear from the context if it is the coefficients or the beam pattern that are referred to.

Let us assume now that we seek to transmit power to L directions, [symbol] =( [symbol] ), [symbol] =1 . . . L. This can be accomplished by setting

$${x}_{m n} = {x}_{m n}^{split} ( {k}_{1} , … , {k}_{L} ) ,$$

where:

$${x}_{m n}^{split} ( {k}_{1} , … , {k}_{L} ) = \frac{{Σ}_{ℓ} {x}_{m n}^{o p t} ( {k}_{ℓ} )}{\vert {Σ}_{ℓ} {x}_{m n}^{o p t} ( {k}_{ℓ} ) \vert} .$$

It can be shown that:

$${\sum }_{ℓ} \vert B ( {k}_{ℓ} ) {\vert}^{2} \approx 0.8 {( MN )}^{2}$$

This can be interpreted as 20% of the power may be lost due to beam splitting; note that this holds for all L>1.

Let us accept that only two phase values are allowed (that is, K=2), as outlined above. Likewise, let us construct the coefficients {xₘₙ} through the beam splitting formula to ensure that the beamforming coefficients have constant magnitude, as is also mentioned above.

Let us recall now that the beam pattern B(kₓ, k_{y}) is a Fourier transform of {xₘₙ}.

Therefore,

$$\vert B ( {k}_{x} , {k}_{y} ) {\vert}^{2} = \vert B ( - {k}_{x} , - {k}_{y} ) {\vert}^{2} ⇒ ∃ {x}_{n m} ∈ ℝ such that \vert {X}_{m n} ( {k}_{x} , {k}_{y} ) {\vert}^{2} \\ = \vert B ( {k}_{x} , {k}_{y} ) {\vert}^{2} where {X}_{mn} ( {k}_{x} , {k}_{y} ) is the Fourier transform of \{ {x}_{nm} \} .$$

Thus, if we deliberately create a beam pattern B(kₓ, k_{y}) such that |B(kₓ, k_{y})|² has the above symmetry, we can obtain strictly real-valued beamforming coefficients. Combining this with the fact that the beamforming coefficients have a constant magnitude by construction, we obtain that xₘₙ∈{±1}, ∀mn.

To create a wide beam, beam splitting may be used, that is, L distinct directional cosines [symbol] can be selected and the beamforming coefficients can be constructed as:

$${x}_{m n} = {x}_{m n}^{split} ( {k}_{1} , … , {k}_{L} , - {k}_{1} , … , - {k}_{L} ) .$$

Note that it was implicitly assumed that [symbol] ≠ [symbol] ≠ [symbol] .

Let us summarise. The beam splitting formula is used, wherefore we obtain constant magnitude coefficients. Symmetry in the beam patterns was created, wherefore we obtain coefficients±1. A beamform is redirected towards 2L directions, each with the width of a pencil beam, wherefore we obtain a beam which is a factor 2L times wider than a pencil beam.

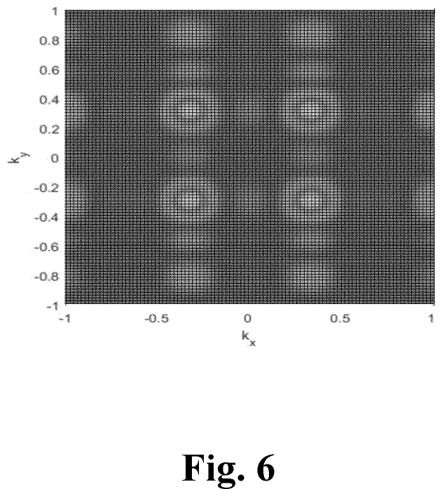

In FIG. 6 below we show an example with L=2. Note that the total beamwidth is the total area of the four dots in FIG. 6.

Let us now consider cases in which more than two phase values (K>2) may be allowed. There may be at least two reasons why K>2 may be advantageous. The first reason is that the beams in FIG. 1 are necessarily symmetric in the sense that |B(kₓ, k_{y})|²=|B(−kₓ, −k_{y})|²; this limits the degrees of freedom in selecting beams. The second reason is a direct consequence of such symmetry. Due to the symmetry, it is not possible to obtain a single “blob” in FIG. 6. This means that high gain pencil beams cannot be achieved.

An implementation with K>2 may allow breaking the mentioned symmetry and obtaining, in general terms, a single blob. How well an approximate to a single blob can be achieved may depend on K. Having said that, examples with multiple blobs will be discussed herein, such multiple blobs (i.e., wide beams) without the symmetry shown in FIG. 6.

To this end, an amended version of the technique for K=2 may be used. For K=2, it is known that the blobs appear in pairs, and that multiple pairs can co-exist through beam splitting. It may therefore suffice to investigate how a single pair of blobs can be placed (i.e., L=1 in above notation). Let us assume that the coefficients xₘₙ∈{±1} creates a pattern B(kₓ, k_{y}) according to the method for K=2 for some directional cosine k=(kₓ, k_{y}). For an arbitrary K=20 with b>1, let us create another set of coefficients yₘₙ according to:

$${y}_{m n} = {x}_{m n} {e}^{i π ( {c}_{x} m + {c}_{y} n )}$$

for some numbers

$${c}_{x} , {c}_{y} ∈ \{ \frac{2 k}{K} , k = 1 - \frac{K}{2} … \frac{K}{2} - 1 \} .$$

By inspection, it can be seen that yₘₙ∈{e^{i2πk/K}, k=0 . . . K−1} so that the coefficients yₘₙ are implementable by K phase levels. The pattern resulting from yₘₙ inherits symmetry properties from xₘₙ, but modified to:

$$\vert B ( {c}_{x} + {k}_{x} , {c}_{y} + {k}_{y} ) {\vert}^{2} = \vert B ( {c}_{x} - {k}_{x} , {c}_{y} - {k}_{y} ) {\vert}^{2} .$$

There is now improved flexibility in the design of beams as we can choose the centers cₓ, c_{y}, as is illustrated in a subsequent example.

In such example, let us choose L=1 and K=4. This choice for L implies that we aim at placing 2 blobs in a figure like FIG. 6. The choice for K implies that

$${c}_{x} , {c}_{y} ∈ \{ - \frac{1}{2} , 0 , \frac{1}{2} \} .$$

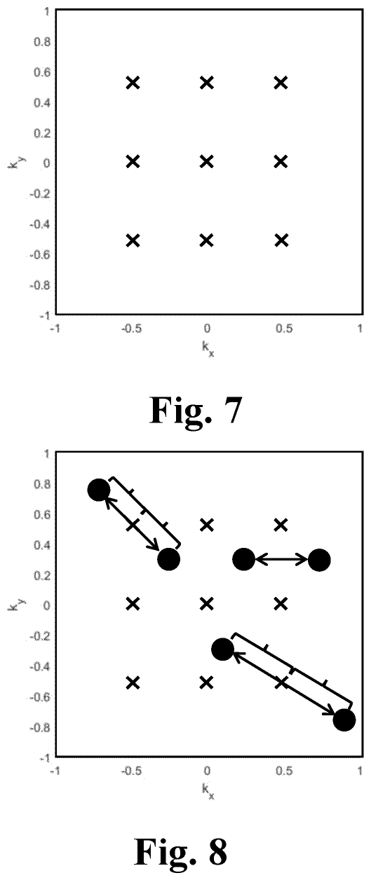

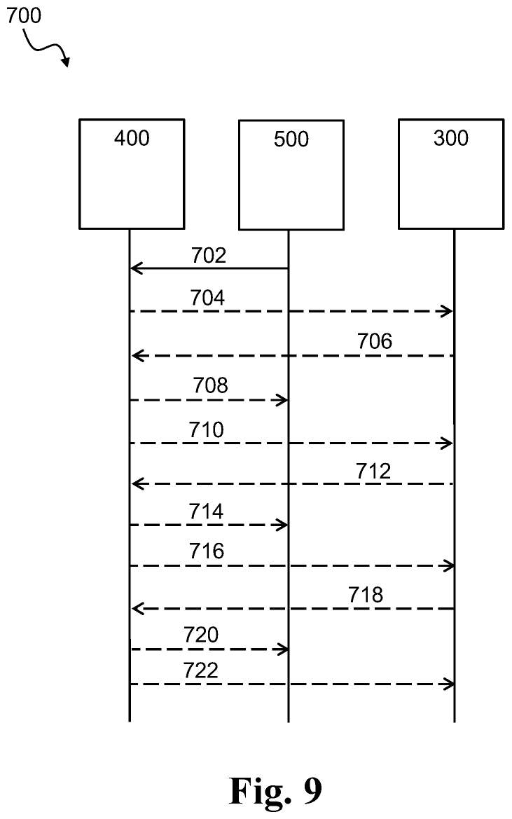

Thus, we can place two blobs symmetric around the 9 markers in FIG. 7. For example, if it is chosen to place our two blobs around the southwestern marker, then cₓ=c_{y}=−½ is chosen. The two blobs that can be placed must have symmetry around each marker, and two different examples are depicted in FIG. 8 (upper left and bottom right) along with one pair of blobs that cannot be obtained. The reason why this pair cannot be obtained is that there exists no center which the pair is symmetric around. To find a narrow beam (for K>2, a narrow beam is one blob; for K=2, a narrow beam is two blobs), a wide beam with 2L constituent beams can initially be used. If a wireless device responds that it can receive the beam, then the CED can be configured with another wide beam with L constituent beams, which are a subset of the original 2L. If the wireless device can no longer receive this beam, then the system may know that the wireless device is in the other subset of L beams. Afterwards, the CED may be configured with L/2 constituent beams, and an iterative process according to such pattern may be established.

FIG. 9 is a signalling diagram illustrating an example communication 700 between a network node 400, a coverage enhancing device, CED, 500, and a wireless device 300 according to the disclosure.

The network node 400 may receive, from the CED 500, control signalling 702 indicative of the CED retransmitting an incident signal as a disjoint wide beam comprising a plurality of sub-beams. Put another way, the CED 500 may report, to the network 400, that the CED 500 intends to retransmit an incident signal as a disjoint wide beam.

The wireless device 300 may receive, from the network node 400, a pre-failure scheduling signalling 704. The pre-failure first scheduling signalling 704 may comprise information about a beam to be used by the wireless device for transmitting intended data. For example, the wireless device 300 receives, from the network node 400, a downlink resource allocation and an uplink grant on a physical downlink control channel (PDCCH) to start transmitting the intended data in an uplink transmission. The wireless device 300 may identify a beam failure and may not be able to transmit the intended data to a destination node.

The wireless device 300 may transmit, to the network node, a failure signal 706 indicative of a beam failure reception by the wireless device 300. A beam pair used for communication between the wireless device 300 and a destination node (e.g., the network node 400) may change as communication channel propagation conditions change due to, for example, movements of the wireless device 300. The wireless device 300 may not be able to communicate with the destination node (e.g., the network node 400) using a current beam (such as, constituent beam 1 according to the third hierarchical level in FIG. 5A; or constituent beam 40A according to the third hierarchical level in FIG. 3B, when the wireless device moves along trajectory 42). The failure signal 706 may be seen as a failure in a reception of a beam (e.g., a signal) by the wireless device 300. The failure signal 706 can, for example, be indicated by a Reference Signal Received Power, RSRP, report and/or a negative-acknowledgement, NACK, message. The wireless device 300 may need to change the current beam to a new beam to communicate with the destination node.

The network node 400 may configure, based on the control signalling 702 and the failure signal 706, a configuration signalling 708. The network node 400 may transmit, to the CED 500, the configuration signalling 708 indicative of a configuration of one or more recovery beams. As a result, the network node may order the CED 500 to configure itself according to the one or more recovery beams that may serve the wireless device 300.

The network node 400 may transmit, to the wireless device 300, a first reference signalling 710 indicative of the one or more recovery beams. The first reference signalling may comprise a channel status information reference signal, CSI-RS.

The wireless device 300 may select (e.g., request the network node 400 to use), based on the first reference signalling 710, a new beam from the one or more recovery beams. In other words, the wireless device 300 may select the new beam for retransmission based on the CSI-RS. The CSI-RS may enable the wireless device 300 to acquire information associated with the communication channel such as information to enable the wireless device 300 to select a new beam (e.g., a best beam from the point of view of the wireless device) from the one or more recovery beams.

In order to select a new beam (e.g., a best beam) from the one or more recovery beams. the wireless device 300 may transmit, to the network node 400, a first beam report signalling 712 (such as a measurement report) indicative of a preferred recovery beam of the one or more recovery beams. The wireless device 300 may report, based on the first reference signalling 710, a preferred recovery beam to the network node 400.

The network node 400 may transmit, to the CED 500, first configuration signalling 714 indicative of the preferred recovery beam. As a result, the network node 400 may order the CED 500 to configure itself according to the preferred recovery beam that may serve the wireless device 300. For example, the preferred recovery beam may be associated with, or may comprise, two or more return beam. For example, the preferred recovery beam may be associated with, or may comprise, a single return beam.

The network node 400 may transmit, to the wireless device 300, a second reference signalling 716 indicative of the preferred recovery beams. This is particularly advantageous when the preferred recovery beam comprises, or is associated with, two or more return beams, because it allows the wireless device 300 to select a new beam (e.g., a best return beam from the preferred recovery beam).

The wireless device 300 may transmit, to the network node 400, a second beam report signalling 718 indicative of a preferred return beam from the plurality of return beams.

Hence, the network node 400 may order the CED 500 to configure itself according to the preferred return beam that may serve the wireless device 300.

The network node 400 may transmit, to the CED 500, second configuration signalling 720 indicative of the preferred return beam. When the preferred recovery beam comprises, or is associated with, a single return beam, the second configuration signalling 720 need not be sent to the CED, because the first configuration signalling 714 suffices for the CED to configure itself according to the preferred return beam.

The network node 400 may transmit, to the wireless device 300, a scheduling signalling 722 indicative of the preferred return beam. The scheduling signalling 722 may be seen as resource allocation signalling which comprises the preferred return beam for serving the wireless device 300. For example, the wireless device 300 receives, from the network node 400, a downlink resource allocation and/or an uplink grant on a PDCCH to start transmitting intended data in an uplink transmission. It may be appreciated that the described method can replace the pre-failure scheduling signalling 704 with the scheduling signalling 722 to allow for a re-establishment of the connection between the wireless device 300 and the network node 400.

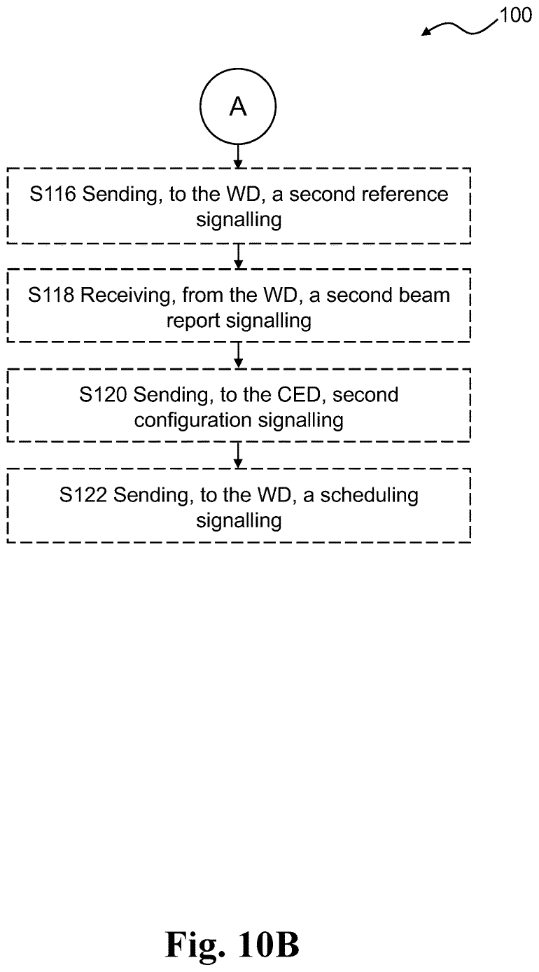

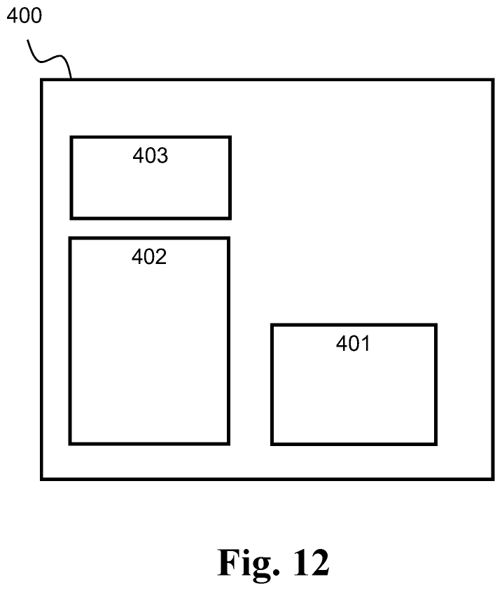

FIGS. 10A-10B show a flow-chart of an example method 100, performed by a network node. The network node is the network node disclosed herein, such as network node 400 of FIG. 1, FIG. 9, and FIG. 12.

The method 100 comprises receiving S102, from a coverage enhancing device (CED), control signalling indicative of the CED retransmitting an incident signal as a disjoint wide beam comprising a plurality of sub-beams.

In one or more example methods, the control signalling comprises a spatial structure of the disjoint wide beam. In one or more example methods, the spatial structure comprises a spatial relationship between the plurality of sub-beams. In one or more example methods, a neighbouring region adjacent to one or more sub-beams of the plurality of sub-beams belongs to the disjoint wide beam in none of a first hierarchical level and a second hierarchical level immediately below the first hierarchical level. As used herein, a “spatial structure of the disjoint wide beam” denotes the distribution, in respect of an angle of departure, of the sub-beams making up the disjoint wide beam. As used herein, “a spatial relationship between the plurality of sub-beams” refers to the relative location, in angle of departure, between two or more sub-beams making up the disjoint wide beam. Therefore, the spatial structure of the disjoint wide beam and/or the spatial relationship between the plurality of sub-beams is a useful indication for the network node to be aware that the CED will imminently retransmit an incident signal as a disjoint wide beam.

In one or more example methods, the method 100 comprises receiving S104, from a wireless device (WD), a failure signal indicative of a beam failure reception by the wireless device. In one or more example or embodiments, the beam failure reception is a failure in the reception of the disjoint wide beam by the wireless device.

In one or more example methods, the method 100 comprises sending S108, to the CED, configuration signalling indicative of a configuration of one or more recovery beams. In one or more example methods, the method 100 comprises configuring S106, based on the control signalling and the failure signal, the configuration signalling.

In one or more example methods, the control signalling comprises an index of the one or more recovery beams. In one or more example or embodiments, the index of the one or more recovery beams associates the one or more recovery beams with the sub-beams of the disjoint wide beam, for example each recovery beam to one or more sub-beams of the disjoint wide beam. In one or more example or embodiments, the configuration signalling is indicative of the association of the index of the one or more recovery beams with the sub-beam of the disjoint wide beam. In one or more examples or embodiments, configuring S106, based on the control signalling and the failure signal, the configuration signalling includes associating the index of the one or more recovery beams with the sub-beams of the disjoint wide beam.

In one or more example methods, the configuration of the one or more recovery beams allows the one or more recovery beams to cover a neighbouring region adjacent to at least one sub-beam of the disjoint wide beam. As explained herein, a disjoint wide beam is a type wide beams that have multiple disjoint narrow ranges of AoDs with high power, referred to as sub-beams. A neighbouring region adjacent to at least one sub-beam denotes a spatial region, in terms of AoD, contiguous to the spatial region occupied by the sub-beam in question. For example, in FIG. 5A, for the example of FIG. 5B-2, recovery beam R1 covers a neighbouring region of sub-beam 1.

In one or more example methods, the one or more recovery beams are associated with a plurality of return beams. In one or more example methods, the one or more recovery beams comprise a plurality of return beams. In one or more example methods, the one or more recovery beams are associated with a single return beam. In one or more example methods, the one or more recovery beams comprise a single return beam. In one or more example methods, the one or more return beams cover the neighbouring region adjacent to at least one sub-beam of the disjoint wide beam.

In one or more example methods, the index of the one or more recovery beams comprises an index of the plurality of return beams. In one or more example or embodiments, the index of the plurality of return beams relates each of the return beams to the index of the disjoint wide beams and their constituent beams according to the different hierarchical levels. The indexes may be part of a codebook.

In one or more example methods, the method 100 comprises sending S110, to the WD, a first reference signalling indicative of the one or more recovery beams.

In one or more example methods, the method 100 comprises receiving S112, from the WD, a first beam report signalling indicative of a preferred recovery beam of the one or more recovery beams. In one or more examples or embodiments, the first beam report signalling is a measurement report.

In one or more example methods, the method 100 comprises sending S114, to the CED, first configuration signalling indicative of the preferred recovery beam.

In one or more example methods, the method 100 comprises sending S116, to the WD, a second reference signalling indicative of the preferred recovery beam. This is particularly advantageous when the preferred recovery beam comprises, or is associated with, two or more return beams. In one or more example methods, the method 100 comprises receiving S118, from the WD, a second beam report signalling indicative of a preferred return beam from the plurality of return beams. In one or more example or embodiments, the second beam report signalling is a measurement report.

In one or more example methods, the method 100 comprises sending S120, to the CED, second configuration signalling indicative of the preferred return beam. When the preferred recovery beam comprises, or is associated with, a single return beam, the second configuration signalling need not be sent to the CED, because the first configuration signalling suffices for the CED to configure itself according to the preferred return beam.

In one or more example methods, the method 100 comprises sending S122, to the WD, a scheduling signalling indicative of the preferred return beam.

In one or more example or embodiments, the wireless device receives a downlink resource allocation and an uplink grant on the physical downlink control channel (PDCCH) to start transmitting its signal as in a normal transmission.

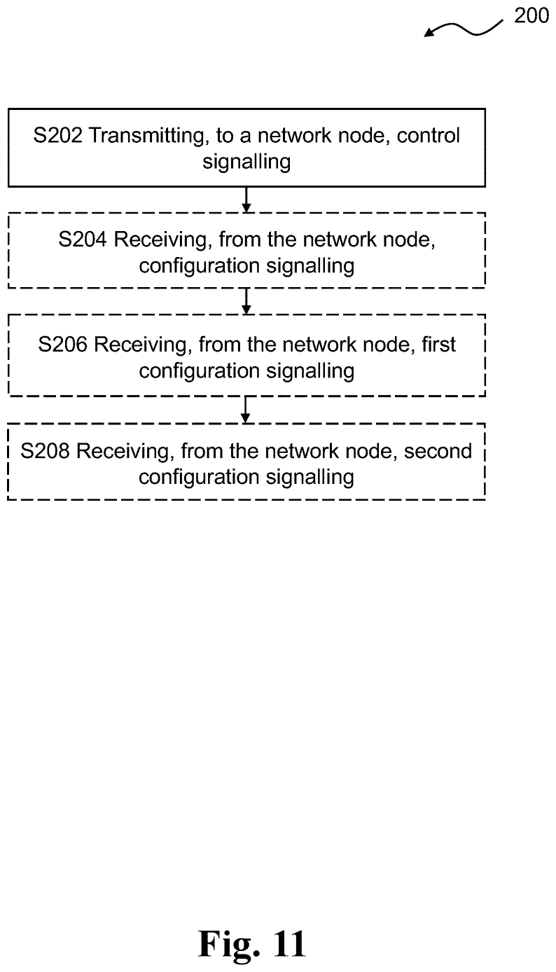

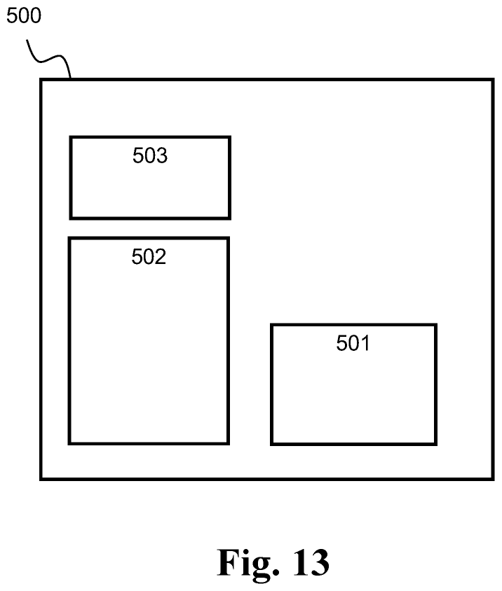

FIG. 11 shows a flow-chart of an example method 200, performed by a coverage enhancing device (CED). The CED is the CED disclosed herein, such as CED 500 of FIG. 1, FIG. 9 and FIG. 13.

The method 200 comprises transmitting S202, to a network node, control signalling indicative of the CED retransmitting an incident signal as a disjoint wide beam comprising a plurality of sub-beams.

In one or more example methods, the control signalling comprises a spatial structure of the disjoint wide beam.

In one or more example methods, the spatial structure comprises a spatial relationship between the plurality of sub-beams. In one or more example methods, a neighbouring region adjacent to one or more sub-beams of the plurality of sub-beams belongs to the disjoint wide beam in none of a first hierarchical level and a second hierarchical level immediately above the first hierarchical level.

In one or more example methods, the method 200 comprises receiving S204, from the network node, configuration signalling indicative of a configuration of one or more recovery beams.

In one or more example methods, the control signalling comprises an index of the one or more recovery beams.

In one or more example methods, the configuration of the one or more recovery beams allows the one or more recovery beams to cover a neighbouring region adjacent to at least one sub-beam of the disjoint wide beam.

In one or more example methods, the one or more recovery beams comprises a plurality of return beams. In one or more example methods, the one or more recovery beams comprise a plurality of return beams. In one or more example methods, the one or more recovery beams are associated with a single return beam. In one or more example methods, the one or more recovery beams comprise a single return beam. In one or more example methods, the one or more return beams cover the neighbouring region adjacent to at least one sub-beam of the disjoint wide beam.

In one or more example methods, the index of the one or more recovery beams comprises an index of the plurality of return beams.

In one or more example methods, the method 200 comprises receiving S206, from the network node, first configuration signalling indicative of the configuration of a preferred recovery beam.

In one or more example methods, the method 200 comprises receiving S208, from the network node, second configuration signalling indicative of the configuration of the preferred return beam.

FIG. 12 shows a block diagram of an example network node 400 according to this disclosure. The network node 400 comprises memory circuitry 401, processor circuitry 402 and a wireless interface 403. The network node 400 may be configured to perform any of the methods disclosed in FIGS. 10A-10B.

The network node 400 is configured to communicate with a coverage enhancing device (CED), such as CED disclosed herein, using a wireless communication system.

The network node 400 is configured to receive (such as via the wireless interface 403), from the CED, control signalling indicative of the CED retransmitting an incident signal as a disjoint wide beam comprising a plurality of sub-beams.

The wireless interface 403 is configured for wireless communications via a wireless communication system, such as a 3GPP system, such as a 3GPP system supporting one or more of: New Radio (NR), Narrow-band IoT (NB-IoT), Long Term Evolution, enhanced Machine Type Communication, LTE-M, millimetre-wave communications (such as millimetre-wave communications in licensed bands or unlicensed bands, such as device-to-device millimetre-wave communications in licensed bands or unlicensed bands), Non-Terrestrial Networks and sidelink communications.

Processor circuitry 402 is optionally configured to perform any of the operations disclosed in FIGS. 10A-10B (such as any one or more of: S102, S104, S106, S108, S110, S112, S114, S116, S118, S120, and S122). The processor circuitry 402 is optionally configured to perform any of the operations, such as method steps, disclosed herein. The operations of the network node 400 may be embodied in the form of executable logic routines (for example, lines of code, software programs, etc.) that are stored on a non-transitory computer readable medium (for example, memory circuitry 401) and are executed by processor circuitry 402.

Furthermore, the operations of the network node 400 may be considered a method that the network node 400 is configured to carry out. Also, while the described functions and operations may be implemented in software, such functionality may also be carried out via dedicated hardware or firmware, or one or more of: hardware, firmware and software.

Memory circuitry 401 may be one or more of: a buffer, a flash memory, a hard drive, a removable media, a volatile memory, a non-volatile memory, a random access memory (RAM) and any other suitable device. In a typical arrangement, memory circuitry 401 may include a non-volatile memory for long term data storage and a volatile memory that functions as system memory for processor circuitry 402. Memory circuitry 401 may exchange data with processor circuitry 402 over a data bus. Control lines and an address bus between memory circuitry 401 and processor circuitry 402 also may be present (not shown in FIG. 12). Memory circuitry 401 is considered a non-transitory computer readable medium.

Memory circuitry 401 may be configured to store the control signalling in a part of the memory.

FIG. 13 shows a block diagram of an example coverage enhancing device (CED) 500 according to this disclosure. The CED 500 comprises memory circuitry 501, processor circuitry 502 and a wireless interface 503. The CED 500 may be configured to perform any of the methods disclosed in FIG. 11.

The CED 500 is configured to communicate with a network node, such as network node disclosed herein 400, using a wireless communication system.

The coverage enhancing device 500 is configured to transmit (such as via the wireless interface 503), to the network node, control signalling indicative of the CED retransmitting an incident signal as a disjoint wide beam comprising a plurality of sub-beams.

The wireless interface 503 is configured for wireless communications via a wireless communication system, such as a 3GPP system, such as a 3GPP system supporting one or more of: New Radio (NR), Narrow-band IoT (NB-IoT), Long Term Evolution, enhanced Machine Type Communication, LTE-M, millimetre-wave communications (such as millimetre-wave communications in licensed bands or unlicensed bands, such as device-to-device millimetre-wave communications in licensed bands or unlicensed bands), Non-Terrestrial Networks and sidelink communications.

Processor circuitry 502 is optionally configured to perform any of the operations disclosed in FIG. 11 (such as any one or more of: such as any or more of S202, S204, S206, and S208). The processor circuitry 502 is optionally configured to perform any of the operations, such as method steps, disclosed herein. The operations of the coverage enhancing device 500 may be embodied in the form of executable logic routines (for example, lines of code, software programs, etc.) that are stored on a non-transitory computer readable medium (for example, memory circuitry 501) and are executed by processor circuitry 502.

Furthermore, the operations of the coverage enhancing device 500 may be considered a method that the coverage enhancing device 500 is configured to carry out. Also, while the described functions and operations may be implemented in software, such functionality may also be carried out via dedicated hardware or firmware, or one or more of: hardware, firmware and software.

Memory circuitry 501 may be one or more of: a buffer, a flash memory, a hard drive, a removable media, a volatile memory, a non-volatile memory, a random access memory (RAM) and any other suitable device. In a typical arrangement, memory circuitry 501 may include a non-volatile memory for long term data storage and a volatile memory that functions as system memory for processor circuitry 502. Memory circuitry 501 may exchange data with processor circuitry 502 over a data bus. Control lines and an address bus between memory circuitry 501 and processor circuitry 502 also may be present (not shown in FIG. 13). Memory circuitry 501 is considered a non-transitory computer readable medium.

Memory circuitry 501 may be configured to store the control signalling in a part of the memory.

Examples of methods and products (network node and coverage enhancing device) according to the disclosure are set out in the following items:

Item 1. A method, performed by a network node, comprising:
receiving (S102), from a coverage enhancing device (CED), control signalling indicative of the CED retransmitting an incident signal as a disjoint wide beam comprising a plurality of sub-beams.

Item 2. The method of item 1, wherein the control signalling comprises a spatial structure of the disjoint wide beam.

Item 3. The method of item 2, wherein the spatial structure comprises a spatial relationship between the plurality of sub-beams whereby a neighbouring region adjacent to one or more sub-beams of the plurality of sub-beams belongs to the disjoint wide beam in none of a first hierarchical level and a second hierarchical level immediately below the first hierarchical level.

Item 4. The method of any of the previous items, the method comprising:
receiving (S104), from a wireless device (WD), a failure signal indicative of a beam failure reception by the WD;
sending (S108), to the CED, configuration signalling indicative of a configuration of one or more recovery beams.

Item 5. The method of item 4, the method comprising:
configuring (S106), based on the control signalling and the failure signal, the configuration signalling.

Item 6. The method of any one of items 4 to 5, wherein the control signalling comprises an index of the one or more recovery beams.

Item 7. The method of any one of items 4 to 6, wherein the configuration of the one or more recovery beams allows the one or more recovery beams, to cover a neighbouring region adjacent to at least one sub-beam of the disjoint wide beam.

Item 8. The method of item 7, wherein the one or more recovery beams comprises and/or is associated with one or more return beams, the one or more return beams covering the neighbouring region adjacent to at least one sub-beam of the disjoint wide beam.

Item 9. The method of item 8 when depending on item 6, wherein the index of the one or more recovery beams comprises an index of the one or more return beams.

Item 10. The method of any one of items 4 to 9, the method comprising:
sending (S110), to the WD, a first reference signalling indicative of the one or more recovery beams.

Item 11. The method of item 10, the method comprising:
receiving (S112), from the WD, a first beam report signalling indicative of a preferred recovery beam of the one or more recovery beams.

Item 12. The method of item 11, the method comprising:
sending (S114), to the CED, first configuration signalling indicative of the preferred recovery beam.

Item 13. The method according to item 12, the method comprising:
sending (S116), to the WD, a second reference signalling indicative of the preferred recovery beams.

Item 14. The method of item 13 when depending on any one of items 8 to 9, the method comprising:
receiving (S118), from the WD, a second beam report signalling indicative of a preferred return beam from the one or more return beams.

Item 15. The method of item 14, the method comprising:
sending (S120), to the CED, second configuration signalling indicative of the preferred return beam.

Item 16. The method of item 15, the method comprising:
sending (S122), to the WD, a scheduling signalling indicative of the preferred return beam.

Item 17. A method, performed by a CED, comprising:
transmitting (S202), to a network node, control signalling indicative of the CED retransmitting an incident signal as a disjoint wide beam comprising a plurality of sub-beams.

Item 18. The method of item 17, wherein the control signalling comprises a spatial structure of the disjoint wide beam.

Item 19. The method of item 18, wherein the spatial structure comprises a spatial relationship between the plurality of sub-beams whereby a neighbouring region adjacent to one or more sub-beams of the plurality of sub-beams belongs to the disjoint wide beam in none of a first hierarchical level and a second hierarchical level immediately above the first hierarchical level.

Item 20. The method of any one of items 17 to 19, the method comprising:
receiving (S204), from the network node, configuration signalling indicative of a configuration of one or more recovery beams.

Item 21. The method of item 20, wherein the control signalling comprises an index of the one or more recovery beams.

Item 22. The method of any one of items 20 to 21, wherein the configuration of the one or more recovery beams allows the one or more recovery beams, to cover a neighbouring region adjacent to at least one sub-beam of the disjoint wide beam.

Item 23. The method of item 22, wherein the one or more recovery beams comprises and/or is associated with one or more return beams, the one or more return beams covering the neighbouring region adjacent to at least one sub-beam of the disjoint wide beam.

Item 24. The method of item 23 when depending on item 21, wherein the index of the one or more recovery beams comprises an index of the one or more return beams.

Item 25. The method of any one of items 20 to 24, the method comprising:
receiving (S206), from the network node, first configuration signalling indicative of the configuration of a preferred recovery beam

Item 26. The method of item 25, the method comprising:
receiving (S208), from the network node, second configuration signalling indicative of the configuration of the preferred return beam.

Item 27. A network node comprising memory circuitry, processor circuitry, and a wireless interface, wherein the network node is configured to perform any of the methods according to any of items 1-16.

Item 28. A CED comprising memory circuitry, processor circuitry, and a wireless interface, wherein the CED is configured to perform any of the methods according to any of items 17-26.

1. A method, performed by a network node, comprising:
receiving, from a coverage enhancing device (CED), control signalling indicative of the CED retransmitting an incident signal as a disjoint wide beam comprising a plurality of sub-beams.

2. The method of claim 1, wherein the control signalling comprises a spatial structure of the disjoint wide beam.

3. The method of claim 2, wherein the spatial structure comprises a spatial relationship between the plurality of sub-beams whereby a neighbouring region adjacent to one or more sub-beams of the plurality of sub-beams belongs to the disjoint wide beam in none of a first hierarchical level and a second hierarchical level immediately below the first hierarchical level.

4. The method of claim 1, the method comprising:
receiving, from a wireless device (WD), a failure signal indicative of a beam failure reception by the WD;
sending, to the CED, configuration signalling indicative of a configuration of one or more recovery beams.

5. The method of claim 4, the method comprising:
configuring, based on the control signalling and the failure signal, the configuration signalling.

6. The method of claim 4, wherein the configuration of the one or more recovery beams allows the one or more recovery beams, to cover a neighbouring region adjacent to at least one sub-beam of the disjoint wide beam.

7. The method of claim 4, wherein the one or more recovery beams comprises and/or is associated with one or more return beams, the one or more return beams covering the neighbouring region adjacent to at least one sub-beam of the disjoint wide beam.

8. The method of claim 7, wherein the one or more recovery beams comprises and/or is associated with one or more return beams, the one or more return beams covering the neighbouring region adjacent to at least one sub-beam of the disjoint wide beam.

9. The method of claim 8, wherein the index of the one or more recovery beams comprises an index of the one or more return beams.

10. The method of claim 4, the method comprising:
sending, to the WD, a first reference signalling indicative of the one or more recovery beams,
receiving, from the WD, a first beam report signalling indicative of a preferred recovery beam of the one or more recovery beams,
sending, to the CED, first configuration signalling indicative of the preferred recovery beam, and
sending, to the WD, a scheduling signalling indicative of a preferred return beam.

11. The method according to claim 10, the method comprising:
sending, to the WD, a second reference signalling indicative of the preferred recovery beams.

12. The method of claim 11, the method comprising:
receiving, from the WD, a second beam report signalling indicative of a preferred return beam from the one or more return beams.

13. The method of claim 12, the method comprising:
sending, to the CED, second configuration signalling indicative of the preferred return beam.

14. A method, performed by a CED, comprising:
transmitting, to a network node, control signalling indicative of the CED retransmitting an incident signal as a disjoint wide beam comprising a plurality of sub-beams.

15. The method of claim 14, wherein the control signalling comprises a spatial structure of the disjoint wide beam.

16. The method of claim 15, wherein the spatial structure comprises a spatial relationship between the plurality of sub-beams whereby a neighbouring region adjacent to one or more sub-beams of the plurality of sub-beams belongs to the disjoint wide beam in none of a first hierarchical level and a second hierarchical level immediately above the first hierarchical level.

17. The method of claim 16, the method comprising:
receiving, from the network node, configuration signalling indicative of a configuration of one or more recovery beams.

18. The method of claim 17, wherein the control signalling comprises an index of the one or more recovery beams.

19. A network node comprising memory circuitry, processor circuitry, and a wireless interface, wherein the network node is configured to perform the method according to claim 1.

20. A CED comprising memory circuitry, processor circuitry, and a wireless interface, wherein the CED is configured to perform the method according to claim 15.
